(19) United States
(12) Patent Application Publication
(10) Pub. No.: US 2008/0247383 A1
(43) Pub. Date: Oct. 9, 2008

(54) Voice over internet protocol phone

(75) Inventors: Zeng-Hui Liu, Naking City (CN); He-Ping Zhang, Naking City (CN)

Correspondence Address: BIRCH STEWART KOLASCH & BIRCH, PO BOX 747, FALLS CHURCH, VA, 22040-0747, US

(73) Assignee: Inventec Appliances Corp., Taipei (TW)

(21) Appl. No.: 12/078,617

(22) Filed: Apr. 2, 2008

(30) Foreign Application Priority Data
Apr. 3, 2007 (TW) 096111884

(51) Int. Cl. H04L 12/66

(52) U.S. Cl. 370/352

(57) ABSTRACT

A VoIP phone includes a signal port, a comparison and distribution module, a first communication protocol module, a second communication protocol module, and a communication interface for a user to dial and talk. The comparison and distribution module is connected with the signal port for sorting signal outputted from the signal port into a first signal and a second signal by respective signal formats of the signals. The first communication protocol module is connected with the comparison and distribution module for processing the first signal and output a processed first signal, and the second communication protocol module is connected with the comparison and distribution module for processing the second signal and output a second processed signal.

### FIELD OF THE INVENTION

The present invention relates to a voice over internet protocol phone, more particular to a voice over internet protocol phone for operating multiple modes of communication protocol simultaneously.

### BACKGROUND OF THE INVENTION

Nowadays, the voice over internet protocol (VoIP) phone plays a vital role in the field of voice communication. The fundamental principle of the VoIP is to code and zip analog voice signals into digital voice signals by the voice zipping and coding/encoding process, and then to upload the digital voice signals to internet with an internet protocol.

Generally speaking, the common type of the internet protocol applied in the VoIP can be an ITU-T Recommendation H.323 (H.323), a Media Gateway Control Protocol (MGCP), a Session Initiation Protocol (SIP), or a SKYPE Communication Protocol, etc. Recently, the SIP and the SKYPE are popular among these internet protocols. The SIP has been approved publicly to be one of critical technologies for integrating the Internet Protocol Network and the Public Switched Telephone Network (PSTN), and adopted to be one of wireless multimedia telecommunication standards for the third generation (3G) mobile communication system. Moreover, for being capable of supporting the Internet Protocol, the IP-PBX, the 3G, and the Soft-Switch, the SIP has been one of the important protocols in the VoIP technologies.

The advantages from simplified technology and the flexibility for fitting the circumstance make the SIP a suitable protocol to be used in the internet, and also a mainstream tool in various enterprises. On the other hand, the SKYPE is popular for PC's users recently because it can make two computers installed with free SKYPE software easy to communicate with each other for free of phone bills.

In the current stage, telecommunication practicians have to develop one by one a specific communication device to account for a particular communication protocol. Namely, the requirement for a local communication device to successfully talk with two other foreign devices with different communication protocols is that the local communication device is simultaneously equipped with those two different communication protocols. To avoid the inconvenience resulting from the aforesaid inconsistence between two communication protocols, it is a trend to integrate two or more communication protocol technologies in one communication device.

### SUMMARY OF THE INVENTION

The primary objective of the present invention is to provide a voice over internet protocol phone capable of handling several communication protocols for overcoming the drawbacks set forth above.

To reach the above objective, the present invention provides the voice over internet protocol (VoIP) phone, which comprises a signal port, a comparison and distribution module, a first communication protocol module, a second communication protocol module and a communication interface for a user to dial and talk. The comparison and distribution module is connected with the signal port for sorting signals outputted from the signal port into a first signal and a second signal by respective signal formats. The first communication protocol module is connected with the comparison and distribution module for processing the first signal and output a processed first signal. The second communication protocol module is connected with the comparison and distribution module for processing the second signal and output a processed second signal.

In a preferred embodiment, an open communication signal is received and processed by the first communication protocol module, while a closed communication signal is received and processed by the second communication protocol module. By integrating a plurality of VoIP technologies into a single terminal facility, the VoIP phone of the present invention can reduce the number of VoIP facilities when the VoIP phone needs to communicate with different internet communication protocols simultaneously and can also provide a unified interface for managing different communication protocol module.

### BRIEF DESCRIPTION OF THE DRAWINGS

The objects, spirits and advantages of the preferred embodiments of the present invention will be readily understood by the accompanying drawings and detailed descriptions, wherein:

FIG. 1 illustrates a schematic view of a voice over internet protocol phone of the present invention;

FIG. 2a and FIG. 2b illustrate respective flow charts of two operating processes for the VoIP phone to receive an incoming call of the present invention; and

FIG. 3 illustrates a flow chart of an operating process for a user to dial a call with the VoIP phone of the present invention.

### DETAILED DESCRIPTION OF THE PREFERRED EMBODIMENTS

The detailed description and technical characteristics of the present invention are described together with the drawings as follows.

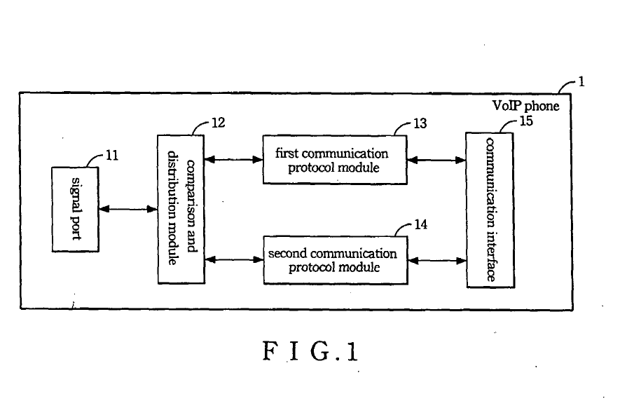

With reference to FIG. 1, which illustrates a schematic structural view of a voice over internet protocol (VoIP) phone of the present invention. As shown in the figure, the VoIP phone includes a signal port 11, a comparison and distribution module 12, a first communication protocol module 13, a second communication protocol module 14, and a communication interface 15 for a user to dial and talk.

The signal port 11 receives internet signals from a cable, a wireless network station, a VoIP gateway, and/or a combination of the above mentioned. The comparison and distribution module 12 is connected with the signal port 11 for sorting signals outputted from the signal port 11. Then, a data comparison list, consisting of a plurality of signals' formats corresponding to a plurality of communication protocol data and being embedded in the comparison and distribution module 12, is adopted to designate a specific format signal into a corresponding gateway for communication. In a preferred embodiment of the invention, two signals can be sorted by the comparison and distribution module 12 into a first signal and a second signal. The first communication protocol module 13 is connected with the comparison and distribution module 12 for processing the first signal output a processed first signal, and the second communication protocol module 14 is connected with the comparison and distribution module 12 for processing the second signal and the corresponding output a processed second signal.

In a preferred embodiment of the invention, the first communication protocol module 13 is an open communication protocol module, a Session Initiation Protocol (SIP) for example, to communicate in the SIP protocol, and the second communication protocol module 14 is a closed communication protocol module 14, a Skype for example, to communicate in the Skype protocol.

When receiving an internet signal outputted from the signal port, the comparison and distribution module 12 determines a communication protocol format corresponding to the internet signal. If the format of the internet signal is an open communication protocol format, the internet signal will be distributed into the first communication protocol module 13 and further transferred into the communication interface 15 after being decoded by the first communication protocol module 13. If the format of the internet signal is a closed communication protocol format, an AES signal with encryption for example, the internet signal will be distributed into the second communication protocol module 14 and transferred into the communication interface 15 after being decoded by the second communication protocol module 14.

The communication interface 15 is a user interface for a user to dial and talk. Since the data format, outputted from either the first communication protocol module 13 or the second communication protocol module 14 and been sent into the communication interface 15, is an audio-video digital data format applied to a typical VoIP phone, a VoIP phone's user can receive a signal outputted from another VoIP facility by the communication interface 15. Furthermore, the VoIP phone's user can output an audio-video signal encoded by the first communication protocol module 13 or the second communication protocol module 14 into the signal port 11 by the communication interface 15.

In the past, as mentioned in the background, a conventional VoIP phone can communicate with others under a single communication protocol. If a user wants to communicate with others by two different communication protocols, a VoIP phone equipped with two different communication protocols is necessary. The aim of the present invention is to disclose a VoIP phone equipped with a plurality of communication protocol modes for a user easy to switch.

In the present invention, a VoIP phone equipped with two communication protocol modes is taken for a preferred embodiment. However, it is understood that the invention is not limited thereto. A further modification of adding the third or the fourth communication protocol module into the VoIP phone of the present invention can be easy anticipated by one skilled in the art, according to the spirit and the teaching of the present invention.

Currently, the SIP communication protocol is popular for telephone extension systems in most of the enterprises. In consideration of reducing the telephone fare, many companies provide a VoIP phone of the SIP communication protocol for internal communication. However, if a user wants to have a conference call with another person outside of the user's company, it is necessary for him/her to communicate the person with a computer or a VoIP phone of SKYPE communication protocol. The VoIP phone of the present invention is to solve the foregoing drawbacks of the conventional VoIP phone by embedding two different communication protocols into a VoIP facility. When receiving an incoming call, the VoIP phone will determine which signal the incoming call is and then decide which communication protocol to process the signal so as to answer the incoming call. Hence, the aforesaid problems of the conventional VoIP phone in inconsistency between two different communication protocols can be solved.

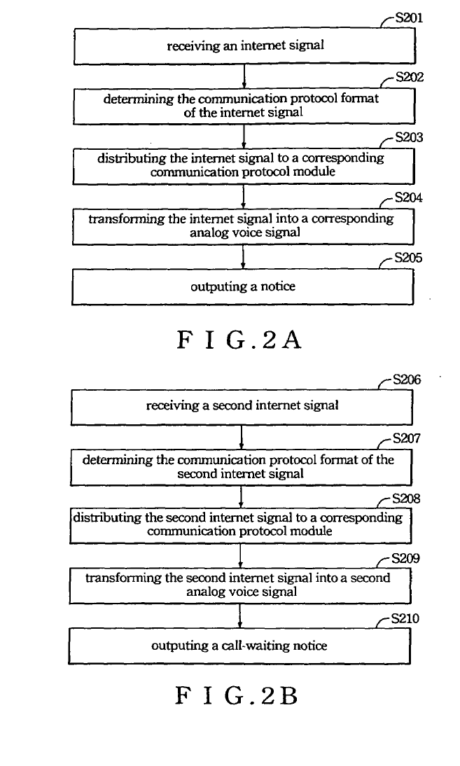

Please refer to FIG. 2A, which illustrates a flow chart of an operating process for the VoIP phone receiving an incoming call of the present invention. In a preferred embodiment of the invention, the incoming call is an internet signal in the SIP communication protocol. The method includes the steps of:

S201: the signal port 11 receiving an internet signal;

S202: the comparison and distribution module 12 determining a corresponding communication protocol format of the internet signal corresponding to the SIP communication protocol;

S203: distributing the first internet signal to a corresponding first communication protocol module 13;

S204: the first communication protocol module 13 transforming the first internet signal into a first analog voice signal: and

S205: the communication interface 15 outputting a notice after receiving the first analog voice signal.

At this moment, a user can make a decision to determine whether answering the notice or not. If it is yes, the communication interface 15 will output the first analog voice signal to start talking. If it is no, the communication will be broken down.

The foregoing description illustrates how a user uses the VoIP phone of the present to receive an SIP signal. When the SIP signal is being received, another communication protocol module (SKYPE module) in the VoIP phone is standby. With reference to FIG. 2B, a flow chart of an operating process for the VoIP phone receiving another incoming signal in a SKYPE communication protocol when the SIP signal is being received is illustrated. The methods include the steps of:

S206: the signal port 11 receiving a second internet signal;

S207: the comparison and distribution module 12 determining the communication protocol format of the second internet signal corresponding to the SKYPE communication protocol;

S208: distributing the second internet signal to the second communication protocol module 14;

S209: the second communication protocol module 14 transforming the second internet signal into a second analog voice signal; and

S210: the communication interface 15 outputting a call-waiting notice and waiting for answering after receiving the second analog voice signal.

At this moment, the user needs to determine if or not to answer another incoming call. If it is yes, the second analog voice signal will be outputted. If it is no, the call-waiting notice will be broken down. Furthermore, a user can edit or preset a plurality of options for operating the VoIP phone 1 through the communication interface 15. For example, one of the options can be to edit the operation of the VoIP phone to hold on/hang up the first incoming call when the user answering the second incoming call. Moreover, the options can be to edit the operation of the VoIP phone not to output a call-waiting notice or to output a call-waiting notice for certain callers.

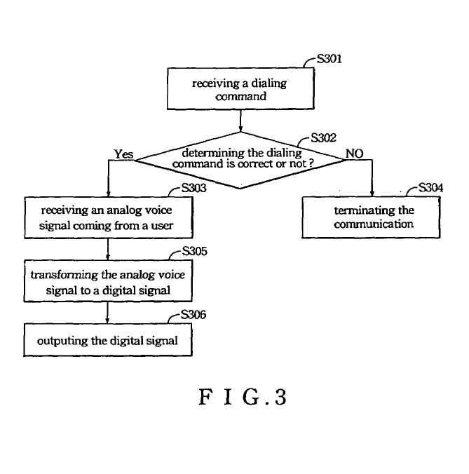

With reference to FIG. 3, it is a flow chart of an operating process for a user dialing a call with the VoIP phone of the present invention. The methods include the steps of:

S301: receiving a dialing command, wherein the user can set a communication protocol format as a primary communication protocol format before dialing through the communication interface 15, wherein the communication protocol format of the dialing command is an SIP communication protocol format;

S302: determining the dialing command is correct or not; if positive, proceeding step S303; and if negative, terminating the communication (S304);

S303: receiving a analog voice signal coming from the user;

S305: the SIP communication protocol module transforming the analog voice signal to a digital signal; and

S306: the signal port 11 outputting the digital signal.

From the aforesaid description, the present invention is superior to the relevant prior art for the following reasons.
1. The VoIP phone of the present invention can integrate a plurality of VoIP technologies into a single terminal facility.
2. The VoIP phone of the present invention provides a unified method for managing different communication protocol modules. Hence, a user can answer an incoming call in the same operating process, no matter what communication protocol the incoming call is.
3. The VoIP phone of the present invention can reduce the number of VoIP facilities when a VoIP phone is conducted with different internet communication protocols simultaneously.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A voice over internet protocol phone, comprising:
a signal port;
a comparison and distribution module connected with the signal port for sorting signals outputted from the signal port into a first signal and a second signal by respective signal formats of the signals;
a first communication protocol module connected with the comparison and distribution module for processing the first signal and output a processed first signal;
a second communication protocol module connected with the comparison and distribution module for processing the second signal and output a processed second signal; and
a communication interface connected with the first communication protocol module and the second communication protocol module for operation by a user.

2. The phone according to claim 1, wherein the signal port receives internet signals from an internet line, a wireless internet station, a VoIP Gateway, and/or a combination of the above mentioned.

3. The phone according to claim 1, wherein the comparison and distribution module further comprising a data comparison list, which includes each of the signal formats having a corresponding communication protocol data.

4. The phone according to claim 1, wherein the first signal is an open communication protocol signal.

5. The phone according to claim 4, wherein the first signal is a Session Initiation Protocol (SIP) signal.

6. The phone according to claim 1, wherein the second signal is a closed communication protocol signal.

7. The phone according to claim 6, wherein the second signal is a skype signal.

8. A method for operating a voice over internet protocol (VoIP) phone, comprising:
receiving an internet signal;
determining a corresponding communication protocol format of the internet signal;
when the internet signal is a first internet signal,
assigning the first internet signal to a first communication protocol module;
transforming the first internet signal into a first analog voice signal;
outputting a notice;
determining whether the phone is answered; and
sending out the first analog voice signal when the phone is answered.

9. The method for operating a voice over internet protocol phone according to claim 8, further comprising the steps of:
receiving a second internet signal;
determining a corresponding communication protocol format of the second internet signal;
assigning the second internet signal to a second communication protocol module;
transforming the second internet signal into a second analog voice signal;
outputting a call-waiting notice;
determining whether the call-waiting is answered; and
outputting the second analog voice signal when the call-waiting is answered.

10. The method for operating a voice over internet protocol phone according to claim 9, wherein the first internet signal is an open communication protocol signal.

11. The method for operating a voice over internet protocol phone according to claim 9, wherein the second internet signal is an closed communication protocol signal.

12. A method for operating a voice over internet protocol phone according to claim 1, comprising the steps of:
receiving a dialing command;
determining a corresponding communication protocol format of the dialing command;
receiving an analog voice signal;
transforming the analog voice signal into a digital signal using the communication protocol format; and
outputting the digital signal.
